(19) United States
(12) Patent Application Publication
(10) Pub. No.: US 2016/0035325 A1
(43) Pub. Date: Feb. 4, 2016

(54) DISPLAY DEVICE, DISPLAY CONTROL CIRCUIT, AND DISPLAY METHOD

(71) Applicant: FUJITSU LIMITED, Kawasaki-shi (JP)

(72) Inventors: Masatoshi KIMURA, Kawasaki (JP); Yasuhiro MATSUSHITA, Kawasaki (JP)

(21) Appl. No.: 14/730,653

(22) Filed: Jun. 4, 2015

(30) Foreign Application Priority Data
Jul. 29, 2014 (JP) 2014-153817

(51) Int. Cl. G09G 5/40; G09G 5/18; G09G 5/10

(52) U.S. Cl. CPC G09G 5/40; G09G 5/10; G09G 5/18; G09G 2330/021; G09G 2340/12

(57) ABSTRACT

A display device displaying image information transmitted from a main body device on a display, the display device includes: an obtaining unit configured to obtain state information of a monitoring object related to a state of the display device; and a control unit configured to update an update table storing the state information in response to periodically obtaining the state information from the obtaining unit, update state display information for visually displaying the state information stored in the update table, and display the state display information in a state of being superimposed on the image information for a given period.

### CROSS-REFERENCE TO RELATED APPLICATION

This application is based upon and claims the benefit of priority from the prior Japanese Patent Application No. 2014-153817 filed on Jul. 29, 2014, the entire contents of which are incorporated herein by reference.

### FIELD

The embodiments disclosed herein are related to, for example, a display device, a display control circuit, and a display method.

### BACKGROUND

A display method is known which for example displays, in a screen of a display provided to a device, the remaining capacity of a battery of the device and a set value of luminance of a backlight, to notify the remaining capacity of the battery and the set value of the luminance of the backlight to a user operating the device. Japanese Laid-open Patent Publication No. 2001-228942 and Japanese Registered Utility Model No. 3,070,933, for example, disclose related technologies. A display method of displaying icons indicating states of the device such as the remaining capacity of the battery, the set value of the luminance, and the like in a state of being superimposed on image information on the display is referred to also as on-screen display (OSD) display.

### SUMMARY

According to an aspect of the embodiment, a display device displaying image information transmitted from a main body device on a display, the display device includes: an obtaining unit configured to obtain state information of a monitoring object related to a state of the display device; and a control unit configured to update an update table storing the state information in response to periodically obtaining the state information from the obtaining unit, update state display information for visually displaying the state information stored in the update table, and display the state display information in a state of being superimposed on the image information for a given period.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a diagram illustrating an example of a hardware configuration of a main body device according to one embodiment;

FIG. 2 is a diagram illustrating an example of a hardware configuration of a display device according to one embodiment;

FIG. 3 is a screen example illustrating an example of icons indicating states of a display device according to one embodiment;

FIG. 4 is a diagram illustrating an example of a display control circuit incorporated in a display device according to one embodiment;

FIG. 5A is a diagram illustrating an example of a register of a universal serial bus (USB) microcomputer according to one embodiment;

FIG. 5B is a diagram illustrating an example of an update table of a decoder processor according to one embodiment;

FIG. 6 is a diagram illustrating an example of BUSY signals of a USB microcomputer and a power supply control microcomputer according to one embodiment;

FIG. 7 is a diagram illustrating an example of a functional configuration of a display device according to one embodiment;

FIG. 8 is a flowchart of an example of battery management processing according to one embodiment;

FIG. 9 is a flowchart of an example of backlight control processing according to one embodiment;

FIG. 10 is a diagram illustrating an example of a backlight control table according to one embodiment;

FIG. 11 is a flowchart of an example of OSD display processing according to one embodiment;

FIG. 12 is a diagram illustrating an example of information obtained by a decoder processor from a USB microcomputer according to one embodiment; and

FIG. 13 is a screen example illustrating an example of OSD display according to one embodiment.

### DESCRIPTION OF EMBODIMENTS

Embodiments of the present technology will hereinafter be described with reference to accompanying drawings. Incidentally, repeated description of constituent elements having substantially identical functional configurations in the present technology and the drawings will be omitted by identifying the constituent elements by the same reference numerals.

An information processing device according to one embodiment of the present technology will be described in the following. The information processing device according to one embodiment has a main body device and a display device removable from the main body device. The display device and the main body device have a physically detachable docking structure. With such a constitution, the information processing device according to the present embodiment allows the display device to be used integrally with the main body device in a state of being docked with the main body device, or allows the display device to be used in a state of being removed from the main body device.

In the information processing device according to the present embodiment, the main body device is a transmitting side apparatus that transmits image information, and the display device is a receiving side apparatus that receives the image information transmitted from the main body device. That is, the main body device operates as an access point (AP), and the display device operates as a station (STA).

The following description will be made of hardware configurations of the main body device and the display device. Description will next be made of functional configurations of the main body device and the display device. Description will thereafter be made of battery management processing, backlight control processing, and OSD display processing.

[Hardware Configuration of Main Body Device]

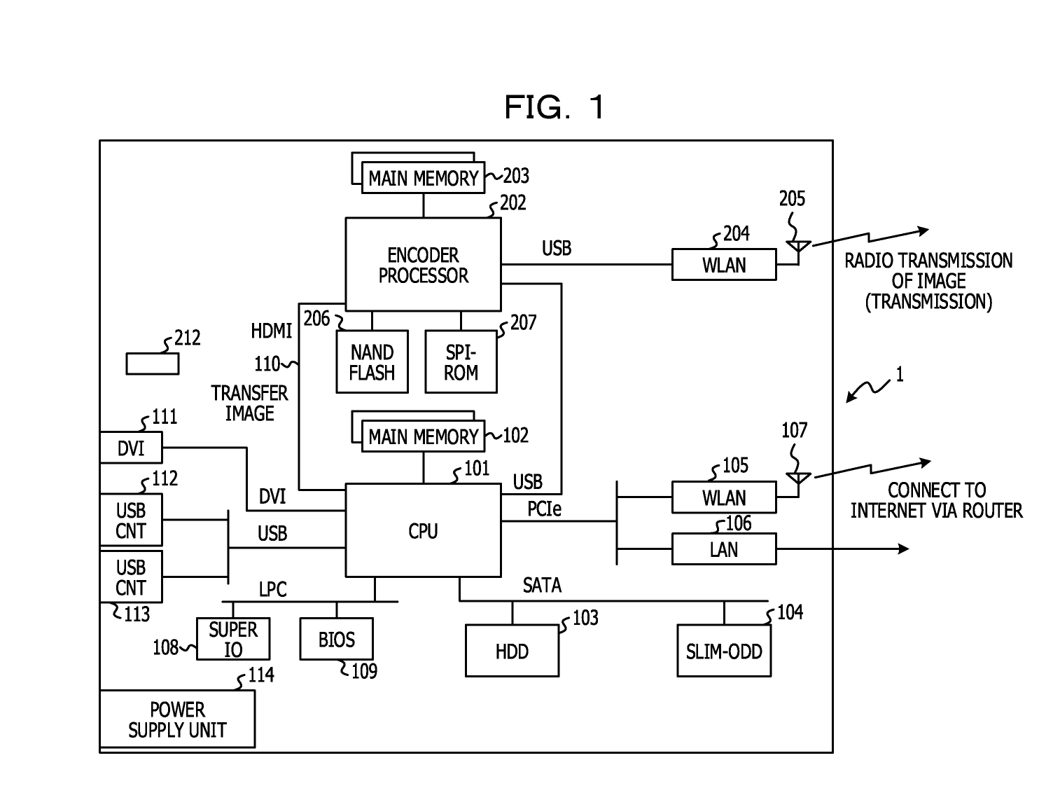

A hardware configuration of a main body device according to one embodiment of the present technology will first be described with reference to FIG. 1. FIG. 1 is a diagram illustrating an example of a hardware configuration of a main body device according to one embodiment.

A main body device 1 according to the present embodiment includes a central processing unit (CPU) 101, a main memory 102, a hard disk drive (HDD) 103, and a slim-optical disk drive (Slim-ODD) 104. The main body device 1 also includes a wireless local area network (WLAN) 105, a local area network (LAN) 106, an antenna 107, and a Super input/output (IO) 108. The main body device 1 also includes a basic input/output system (BIOS) memory 109, a high definition multimedia interface (HDMI) (registered trademark) 110, and a digital visual interface (DVI) 111. The main body device 1 further includes a universal serial bus controller (USBCNT) 112, a USBCNT 113, and a power supply unit 114.

In addition, the main body device 1 according to the present embodiment includes an encoder processor 202, a main memory 203, a WLAN 204, an antenna 205, a NAND flash memory 206, a serial peripheral interface-read only memory (SPI-ROM) 207, and a docking structure 212.

The CPU 101 is an example of a main processing circuit in the main body device 1. The main memory 102, the HDD 103, and the Slim-ODD 104 are connected to the CPU 101 via buses. In addition, the WLAN 105, the LAN 106, the Super IO 108, the BIOS memory 109, the HDMI 110, the DVI 111, the USBCNT 112, and the USBCNT 113 are connected to the CPU 101 via buses. The WLAN 105 is connected to the antenna 107. The power supply unit 114 is a power supply for supplying power to various parts such as the CPU 101 and the like. FIG. 1 does not illustrate lines for power supply from the power supply unit 114 to the various parts.

The HDD 103 is a nonvolatile storage device storing a program and data. The HDD 103 stores a basic application (program) for controlling the whole of the information processing device. The program and the data stored on the HDD 103 include an operating system (OS) as basic software controlling the whole of the device and application software providing various kinds of functions on the OS. The HDD 103 stores the OS, an installed application, an uninstaller, a registry, and the like.

The Slim-ODD 104 is an optical disk drive. When a distribution version of an application, update data, and the like are distributed on an optical disk, the Slim-ODD 104 reads data from the distributed optical disk, and stores the data.

The WLAN 105 performs radio communication via the antenna 107. The WLAN 105 is connected to a network such as the Internet or the like via a router, and transmits and receives data to and from the outside. The LAN 106 is also connected to a network such as the Internet or the like, and transmits and receives data to and from the outside. The distribution version of the application, the update data, and the like may be downloaded via the WLAN 105 or the LAN 106, for example.

The Super IO 108 is an input-output interface. A keyboard and a mouse, for example, may be connected to the Super IO 108. The BIOS memory 109 is a nonvolatile storage device storing a program group (for example a BIOS) for controlling a disk drive, a keyboard, a video card, and the like connected to a computer.

The HDMI 110 is an interface for transmitting digital video and audio. In the present embodiment, image information and the like stored in the main body device 1 are transmitted by radio from the main body device 1 to a display device 3 side via the HDMI 110.

The DVI 111 is for example an interface that may be connected to a monitor to output image information and the like stored in the main body device 1 to the monitor. The USBCNTs 112 and 113 are control circuits for USB devices connected to USB connectors of the main body device 1.

The main memory 203, the NAND flash memory 206, and the SPI-ROM 207 are connected to the encoder processor 202 via buses. The WLAN 204 is connected to the encoder processor 202 via a USB. In addition, the WLAN 204 is connected to the antenna 205, and transmits the image information of the main body device 1 to the display device 3.

The encoder processor 202 is a dedicated processor that consumes lower power than the CPU 101 and which is intended to perform processing of fewer functions than the CPU 101. The image information of the main body device 1 is input from the CPU 101 to the encoder processor 202 via the HDMI 110. The encoder processor 202 for example compresses and encodes the image information and thereafter transmits the image information to the display device 3 via the WLAN 204.

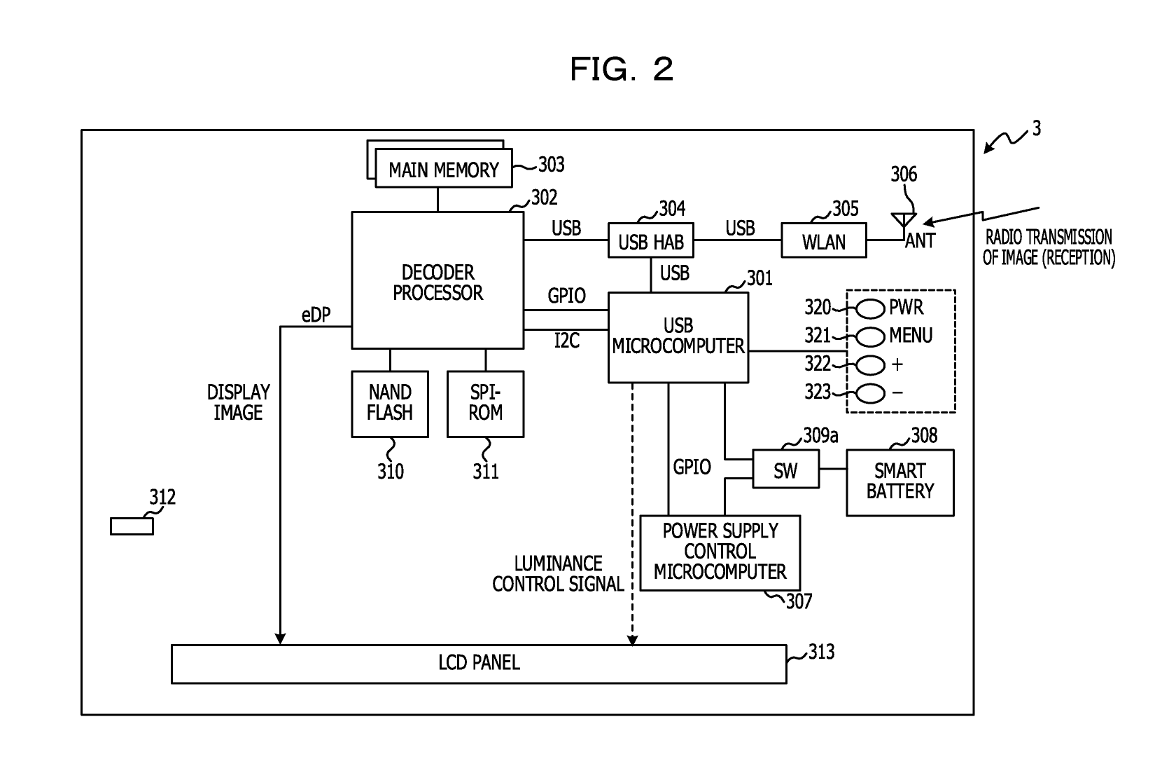

The docking structure 212 is a connector having a structure capable of being coupled to a docking structure 312 illustrated in FIG. 2. The docking structure 212 is provided with a plurality of terminals. Physical docking of the docking structure 212 with the docking structure 312 may establish electric connection between the main body device 1 and the display device 3.

[Hardware Configuration of Display Device]

A hardware configuration of a display device according to one embodiment of the present technology will next be described with reference to FIG. 2. FIG. 2 is a diagram illustrating an example of a hardware configuration of a display device according to one embodiment.

The display device 3 according to the present embodiment includes a USB microcomputer 301, a decoder processor 302, a main memory 303, a USB hub 304, a WLAN 305, and an antenna 306. The display device 3 also includes a power supply control microcomputer 307, a smart battery 308, and a switch (SW) 309a. The display device 3 also includes a NAND flash memory 310, an SPI-ROM 311, a docking structure 312, and a liquid crystal display (LCD) panel 313. The display device 3 further includes a power supply (PWR) button 320, a Menu button 321, an up (+) button 322, and a down (−) button 323.

The decoder processor 302 is connected to the USB microcomputer 301, the main memory 303, the USB hub 304, the NAND flash memory 310, and the SPI-ROM 311 via buses. The WLAN 305 is connected to the decoder processor 302 via the USB hub 304. The WLAN 305 is connected to the antenna 306, and receives image information from the encoder processor 202 of the main body device 1. The USB hub 304 relays between the WLAN 305 and the decoder processor 302. The decoder processor 302 decompresses and decodes the transferred image information, and displays the image information on the LCD panel 313. The LCD panel 313 is an example of a display (display unit) provided to the display device 3. The docking structure 312 is a connector having a structure capable of being coupled to the docking structure 212.

The USB microcomputer 301 controls the LCD panel 313 on the basis of a luminance control signal. The luminance control signal has on and off information and luminance value information of a backlight of the LCD panel 313. The USB microcomputer 301 performs on and off control of the backlight of the LCD panel 313 and adjusts the brightness of the backlight on the basis of the luminance control signal.

The power supply control microcomputer 307 manages power to the whole of the system. For example, the power supply control microcomputer 307 outputs a BUSY signal to be described later to the USB microcomputer 301, accesses the smart battery 308, and performs charge control of the smart battery 308. The smart battery 308 may retain battery information such as battery remaining capacity information or the like.

For example, when a user presses the Menu button 321, the USB microcomputer 301 obtains the battery information managed by the smart battery 308, and stores the battery information in a register to be described later. The luminance information and the battery information managed by the USB microcomputer 301 are sent to the decoder processor 302 in given timing.

The switch 309a switches connection in response to a request for access from the power supply control microcomputer 307 to the smart battery 308 and a request for access from the USB microcomputer 301 to the smart battery 308. A switching method will be described later. One of the power supply control microcomputer 307 and the USB microcomputer 301 is thereby permitted to access the smart battery 308.

The decoder processor 302 is a dedicated processor that consumes lower power than the CPU 101 and which is intended to perform processing of fewer functions than the CPU 101. Thus, the portable display device 3 may be reduced in weight. The NAND flash memory 310 and the SPI-ROM 311 store various kinds of data and programs such as a program executed by the decoder processor 302 and the like.

The decoder processor 302 monitors the state of a radio wave in radio communication using the antenna 306 and retains radio wave information indicating the level of the radio wave at the time of the monitoring. The decoder processor 302 obtains state information of monitoring objects among states of the display device 3. In the present embodiment, luminance information, battery information, and radio wave information are cited as an example of the state information of the monitoring objects related to states of the display device 3. However, the state information of the monitoring objects may be other information related to states of the display device 3.

The decoder processor 302 makes OSD display of state display information for visually displaying the state information for a given period such that the state display information is superimposed on image information on the LCD panel 313. When the state information is updated, the decoder processor 302 displays the state display information for visually displaying the updated state information. The state display information such as icons or the like is therefore changed during the given period. Thus, the user may visually recognize changes in the states of the display device 3.

An example of timing in which the decoder processor 302 controls OSD display is when the user presses the Menu button 321 and accordingly an OSD display request (OSD_ON pulse signal) is issued from the USB microcomputer 301. Other examples are when the user changes a luminance value and when the battery remaining capacity of the smart battery 308 is equal to or lower than 12% of a maximum capacity of the battery and accordingly an OSD display request is issued from the USB microcomputer 301. However, the battery remaining capacity whose OSD display is requested is not limited to 12%, but may be another percentage. In addition, in the case where the battery remaining capacity is equal to or lower than 12%, even when there is no user operation, OSD display of an icon indicating the battery remaining capacity is made to notify the user that the battery remaining capacity is low.

Cases where the decoder processor 302 controls OSD display even when no OSD_ON pulse signal is issued include a case where the radio wave is about to be interrupted and a case where the radio wave is interrupted. The user may therefore be notified of a poor radio wave state. Incidentally, times when the user changes the luminance value include a time when the user gives an instruction to change the luminance value by pressing the up (+) button 322 or the down (−) button 323. When the Menu button 321, the up (+) button 322, or the down (−) button 323 is thus pressed, the USB microcomputer 301 requests the decoder processor 302 to make OSD display of the luminance information and the battery information.

Image information may always be transferred between the decoder processor 302 and the encoder processor 202, and the image information is displayed on the LCD panel 313. When the decoder processor 302 is made to perform processing different from image information transfer processing in this state, the image information transfer processing may be interrupted temporarily, which may invite a degradation in the quality of video displayed on the LCD panel 313. Hence, the decoder processor 302 according to the present embodiment refrains as much as possible from performing processing other than the image information transfer processing to ensure stability of the quality of the video displayed on the LCD panel 313.

Accordingly, in the present embodiment, the USB microcomputer 301 manages the luminance information as one piece of state information of a monitoring object, and obtains the battery information and the like. The decoder processor 302 then obtains the luminance information and the battery information from the USB microcomputer 301 in given timing. The decoder processor 302 displays icons for visually displaying the obtained luminance information and the obtained battery information such that the icons are superimposed on the image information. The decoder processor 302 may therefore refrain as much as possible from performing processing other than the image information transfer processing.

In the present embodiment, the decoder processor 302 adds the icon of the radio wave information to the icon of the luminance information and the icon of the battery remaining capacity information, the luminance information and the battery remaining capacity information being obtained by the USB microcomputer 301, and makes OSD display of the three icons indicating the states of the display device 3 such that the three icons are superimposed on image information on the LCD panel 313.

[Example of Icons and the Like]

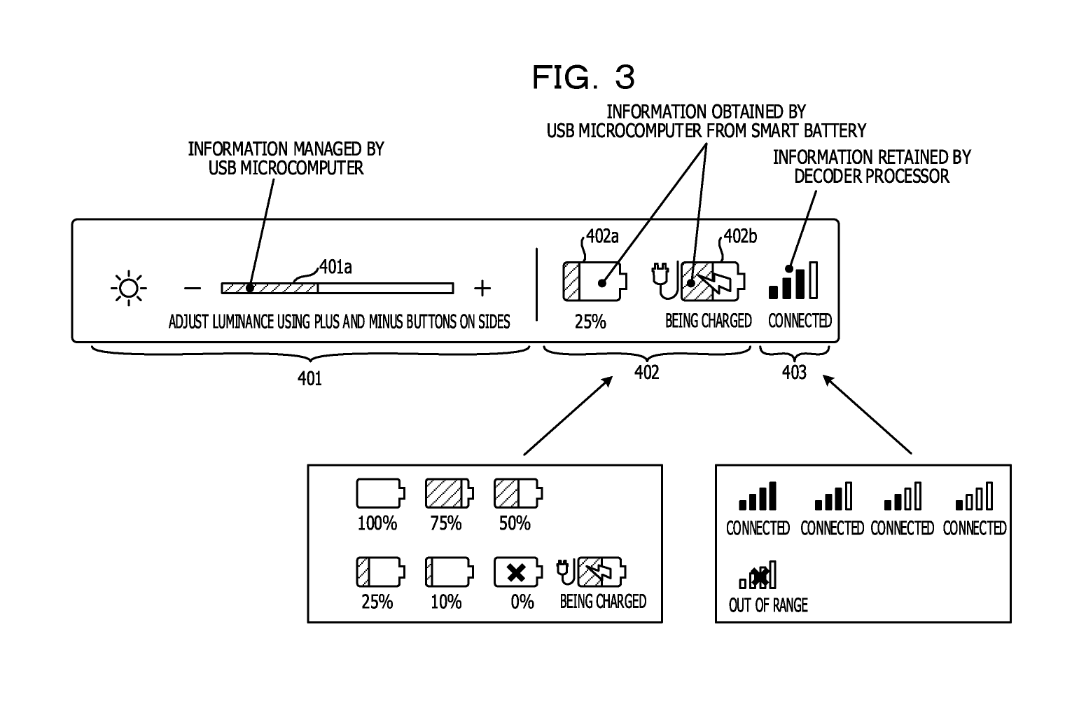

An example of icons and the like displayed on the LCD panel by the decoder processor will be described with reference to FIG. 3. FIG. 3 is a screen example illustrating an example of icons indicating states of a display device according to one embodiment. The state display information such as icons and the like for visually displaying the state information of the monitoring objects includes an icon 401 including gage length information 401a indicating the luminance value, an icon 402 including battery remaining capacity information 402a and charge information 402b, and an icon 403 indicating radio wave information. The luminance information is information managed by the USB microcomputer 301. The battery remaining capacity information is information that the USB microcomputer 301 obtains from the smart battery 308. The icon 403 indicating the radio wave information is information retained by the decoder processor 302.

The icon 401 visually displays the luminance value by the gage length information 401a. The user may adjust the luminance value of the LCD panel 313 by touching a plus button or a minus button on a side, the plus button and the minus button being included in the icon 401. Incidentally, the user may also adjust the luminance value by pressing the up (+) button 322 or the down (−) button 323.

The icon 402 visually displays the battery remaining capacity information 402a and the charge information 402b. In FIG. 3, as an example of the icon of the battery remaining capacity information 402a indicating the battery remaining capacity, batteries indicating remaining capacities in a range of 0% to 100% (step of 1%, for example) are displayed. However, the battery remaining capacity information 402a has remaining capacity information of the smart battery 308 which remaining capacity information may be displayed in steps of 1% in a range of 0% to 100%.

In addition, while the smart battery 308 is being charged, the icon of the charge information 402b is displayed. When the smart battery 308 is not being charged, the icon of the charge information 402b is set in a non-display state, or a denotation of “x” is added to the icon of the charge information 402b to indicate to the user that the smart battery 308 is not being charged.

Further, the icon 403 indicating the radio wave information is displayed with “connected” when the radio communication of the WLAN 204 and the WLAN 305 is possible, and a denotation obtained by filling in bars of the icon 403 indicating the radio wave information indicates a radio wave state (radio field intensity) in the radio communication. Incidentally, when the radio communication of the WLAN 204 and the WLAN 305 is not possible, an icon 403 with “out of range” is displayed. The decoder processor 302 displays these icons 401, 402, and 403 in a state of being superimposed on image information on the screen of the LCD panel 313 (OSD display).

[Display Control Circuit]

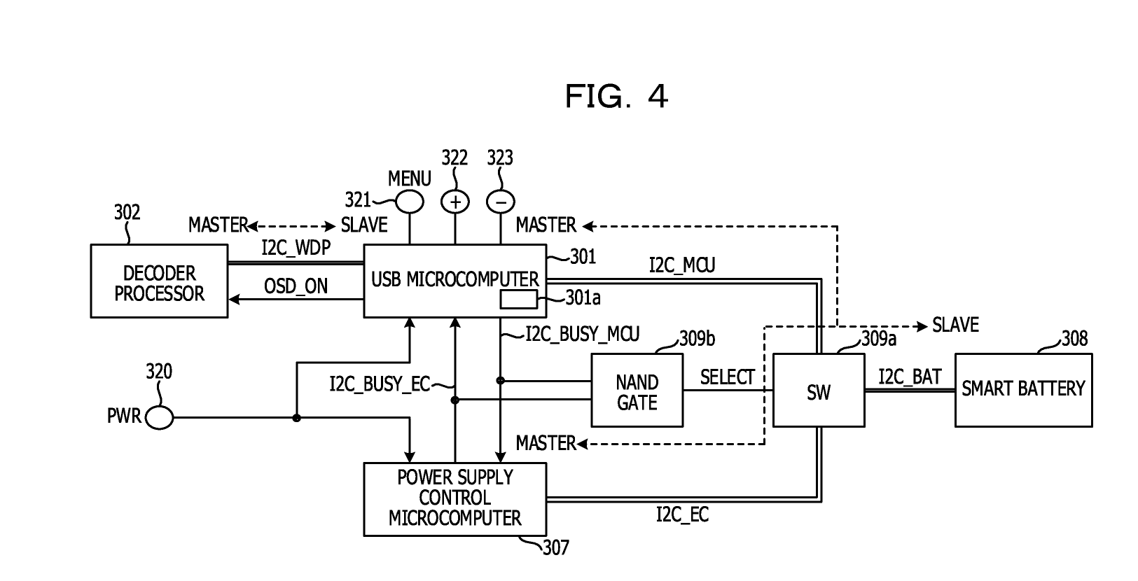

Description will next be made of an example of a display control circuit incorporated in a display device according to the present embodiment. FIG. 4 is a diagram illustrating an example of a display control circuit incorporated in a display device according to one embodiment. As illustrated in FIG. 4, a display control circuit including the decoder processor 302 and the USB microcomputer 301 is incorporated in the display device 3. The USB microcomputer 301 is an example of a microcomputer that obtains the state information of the monitoring objects related to states of the display device 3.

The decoder processor 302 periodically obtains the state information from the USB microcomputer 301. The decoder processor 302 is an example of a processor that updates state information stored in an update table on the basis of the obtained state information, updates state display information for visually displaying the state information stored in the update table according to the update, and displays the updated state display information in a state of being superimposed on image information for a given period.

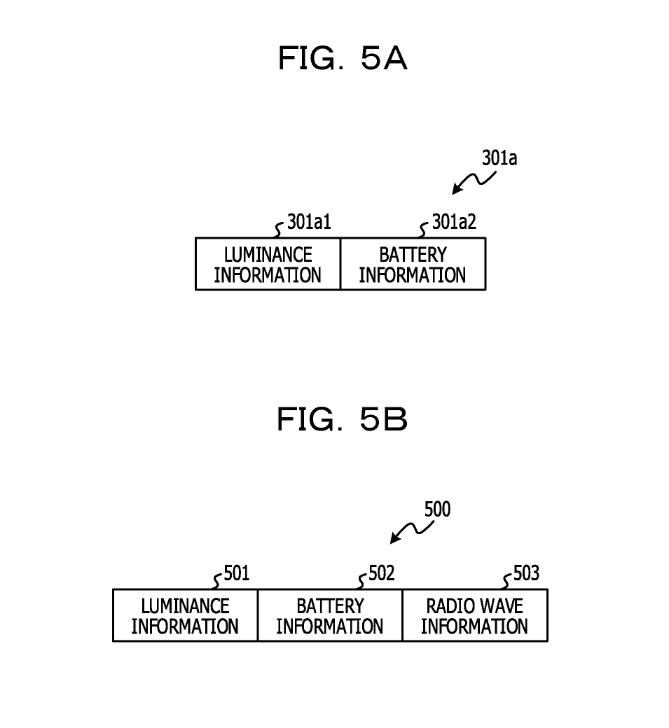

FIGS. 5A and 5B are diagrams illustrating examples of a register of a USB microcomputer and an update table of a decoder processor, respectively, according to one embodiment. As illustrated in FIG. 5A, a register 301a provided in the USB microcomputer 301 stores luminance information 301a1 managed by the USB microcomputer 301 and battery information 301a2 obtained by the USB microcomputer 301 from the smart battery 308. The luminance information 301a1 includes the gage length information. The decoder processor 302 obtains the luminance information 301a1 from the USB microcomputer 301. The decoder processor 302 also obtains the battery information 301a2 from the USB microcomputer 301. The battery information 301a2 includes information indicating whether the battery is connected, indicating a percentage to which the battery is charged (battery remaining capacity information), and indicating whether the battery is being charged, for example.

The luminance information 301a1 and the battery information 301a2 obtained by the decoder processor 302 are stored in an update table 500 illustrated in FIG. 5B. The update table 500 illustrated in FIG. 5B represents an example of the update table 500 managed by the decoder processor 302. The update table 500 retains luminance information 501, battery information 502, and radio wave information 503. The decoder processor 302 stores radio field intensity in the radio communication with the main body device 1 as the radio wave information 503 in the update table 500. The decoder processor 302 obtains the luminance information 301a1 and the battery information 301a2 from the USB microcomputer 301, and updates the luminance information 501 and the battery information 502 stored in the update table 500 on the basis of the obtained information.

Returning to FIG. 4, the display control circuit according to the present embodiment includes the smart battery 308 having an inter-integrated circuit (I2C) interface. The smart battery 308 may internally manage information related to charge and discharge (that is, “battery information”), and may send the battery information to the power supply control microcomputer 307 and the USB microcomputer 301.

The smart battery 308 functions as a slave device with respect to the power supply control microcomputer 307 and the USB microcomputer 301. That is, the power supply control microcomputer 307 and the USB microcomputer 301 function as a master device with respect to the smart battery 308. The power supply control microcomputer 307 and the USB microcomputer 301 may access the smart battery 308 via I2C, but not vice versa.

Similarly, the USB microcomputer 301 functions as a slave device with respect to the decoder processor 302. That is, the decoder processor 302 functions as a master device with respect to the USB microcomputer 301. Hence, the decoder processor 302 may access the USB microcomputer 301 via I2C, but not vice versa.

The power supply control microcomputer 307 and the USB microcomputer 301 issue a BUSY signal when requesting access to the smart battery 308 by using I2C. For example, when the power supply control microcomputer 307 is to perform charge control of the smart battery 308, the power supply control microcomputer 307 sets a BUSY signal (I2C_BUSY_EC) to “1: BUSY,” and issues the BUSY signal (I2C_BUSY_EC) to the USB microcomputer 301. For example, when the USB microcomputer 301 is to obtain the battery remaining capacity information from the smart battery 308, the USB microcomputer 301 sets a BUSY signal (I2C_BUSY_MCU) to “0: BUSY,” and issues the BUSY signal (I2C_BUSY_MCU) to the power supply control microcomputer 307.

A NAND Gate 309b selects the power supply control microcomputer 307 or the USB microcomputer 301 according to the states of the BUSY signal (I2C_BUSY_EC) and the BUSY signal (I2C_BUSY_MCU). The switch 309a switches between I2C_MCU and I2C_EC so as to allow the microcomputer selected according to a result of the selection to use I2C. Thus, the microcomputer that may access the smart battery 308 may be switched between the USB microcomputer 301 and the power supply control microcomputer 307.

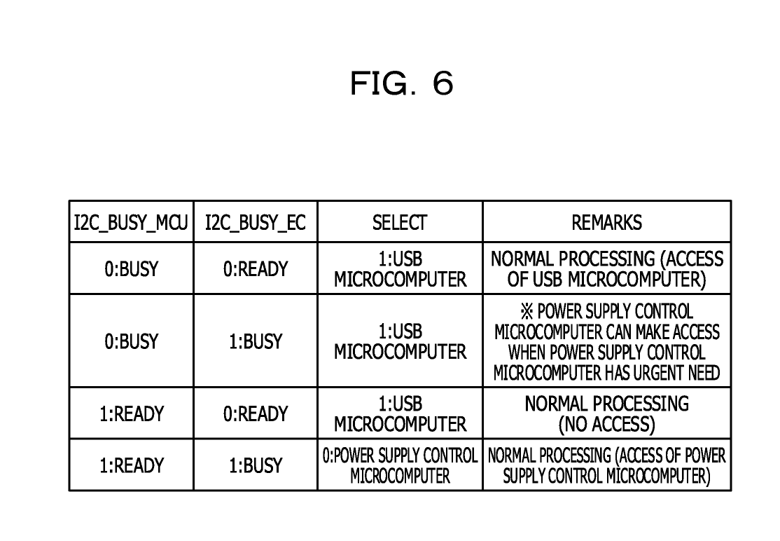

Referring to FIG. 6, description will be further continued about the switching (selection) of the microcomputer according to the states of the BUSY signal (I2C_BUSY_EC) and the BUSY signal (I2C_BUSY_MCU). FIG. 6 is a diagram illustrating an example of BUSY signals of a USB microcomputer and a power supply control microcomputer according to one embodiment.

When the BUSY signal (I2C_BUSY_MCU) issued by the USB microcomputer 301 is “0,” the BUSY signal (I2C_BUSY_MCU) indicates a state of access being requested. When the BUSY signal (I2C_BUSY_MCU) issued by the USB microcomputer 301 is “1,” the BUSY signal (I2C_BUSY_MCU) indicates a state of access not being requested. On the other hand, when the BUSY signal (I2C_BUSY_EC) issued by the power supply control microcomputer 307 is “1,” the BUSY signal (I2C_BUSY_EC) indicates a state of access being requested. When the BUSY signal (I2C_BUSY_EC) issued by the power supply control microcomputer 307 is “0,” the BUSY signal (I2C_BUSY_EC) indicates a state of access not being requested.

When the BUSY signal (I2C_BUSY_MCU) is “0,” and the BUSY signal (I2C_BUSY_EC) is “0,” the USB microcomputer 301 is requesting access, and the power supply control microcomputer 307 is not requesting access. At this time, the NAND Gate 309b selects the USB microcomputer 301, and allows access from the USB microcomputer 301 to the smart battery 308 by switching the switch 309a.

When the BUSY signal (I2C_BUSY_MCU) is “0,” and the BUSY signal (I2C_BUSY_EC) is “1,” both of the USB microcomputer 301 and the power supply control microcomputer 307 are requesting access. At this time, the NAND Gate 309b selects the USB microcomputer 301, and allows access from the USB microcomputer 301 to the smart battery 308 by switching the switch 309a.

However, the power supply control microcomputer 307 manages power to the whole of the system. Hence, when the power supply control microcomputer 307 has an urgent need, for example when an abnormal temperature, an overcurrent, or the like is detected, the access request of the power supply control microcomputer 307 may need to be given priority to control the power to the whole of the system. Accordingly, when the power supply control microcomputer 307 has an urgent need, regardless of whether or not the BUSY signal (I2C_BUSY_MCU) is “0,” the power supply control microcomputer 307 sets the BUSY signal (I2C_BUSY_EC) high (that is, “1”), and requests a right to I2C control (access request). At this time, the USB microcomputer 301 immediately suspends access to the smart battery 308 via I2C, and sets the BUSY signal (I2C_BUSY_MCU) to “1.” Thus, switching is performed so as to enable the power supply control microcomputer 307 to use I2C. Therefore access is allowed from the power supply control microcomputer 307 to the smart battery 308 at a time of emergency.

When the BUSY signal (I2C_BUSY_MCU) is “1,” and the BUSY signal (I2C_BUSY_EC) is “0,” both of the USB microcomputer 301 and the power supply control microcomputer 307 are not requesting access. At this time, the NAND Gate 309b selects the USB microcomputer 301. However, access to the smart battery 308 is not made.

When the BUSY signal (I2C_BUSY_MCU) is “1,” and the BUSY signal (I2C_BUSY_EC) is “1,” the USB microcomputer 301 is not requesting access, but the power supply control microcomputer 307 is requesting access. At this time, the NAND Gate 309b selects the power supply control microcomputer 307, and allows access from the power supply control microcomputer 307 to the smart battery 308 by switching the switch 309a.

[Functional Configuration of Display Device]

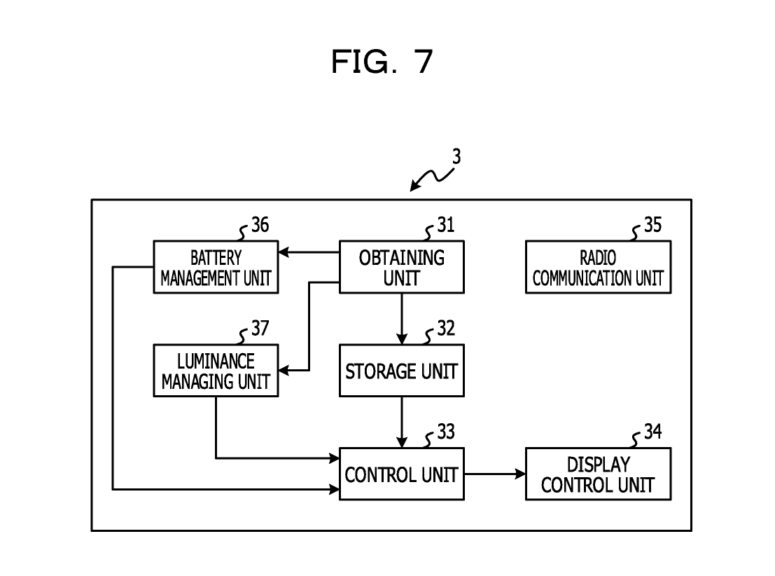

An example of the functional configuration of a display device according to the present embodiment will next be described with reference to FIG. 7. FIG. 7 is a diagram illustrating an example of a functional configuration of a display device according to one embodiment. The display device 3 includes an obtaining unit 31, a storage unit 32, a control unit 33, a display control unit 34, a radio communication unit 35, a battery managing unit 36, and a luminance managing unit 37.

The obtaining unit 31 obtains the state information of the monitoring objects related to states of the display device 3. In the present embodiment, the monitoring objects related to the states of the display device 3 include the luminance information, the battery information, and the radio wave information. Among the pieces of information, the obtaining unit 31 obtains the luminance information and the battery information. The battery information is obtained from the smart battery 308.

The storage unit 32 updates the update table 500 on the basis of the state information periodically obtained from the obtaining unit 31. The storage unit 32 updates the update table 500 each time the state information of one of the plurality of monitoring objects is obtained.

The control unit 33 updates the state display information for visually displaying the state information stored in the update table 500 according to the update of the update table 500, and displays the state display information in a state of being superimposed on image information for a given period.

The display control unit 34 makes OSD display for a given period while updating the state display information. The radio communication unit 35 receives the image information from the main body device 1 by radio communication.

The battery managing unit 36 manages the battery information obtained from the smart battery 308 in given timing. The luminance managing unit 37 controls brightness of the backlight of the LCD panel 313 of the display device 3 on the basis of the luminance information.

Incidentally, in the present embodiment, the functions of the obtaining unit 31, the battery managing unit 36, and the luminance managing unit 37 are implemented mainly by the USB microcomputer 301. The functions of the control unit 33 and the display control unit 34 are implemented mainly by the decoder processor 302. The functions of the storage unit 32 are implemented mainly by the NAND flash memory 310 and the like. The functions of the radio communication unit 35 are implemented mainly by the WLAN 305.

[Battery Management Processing]

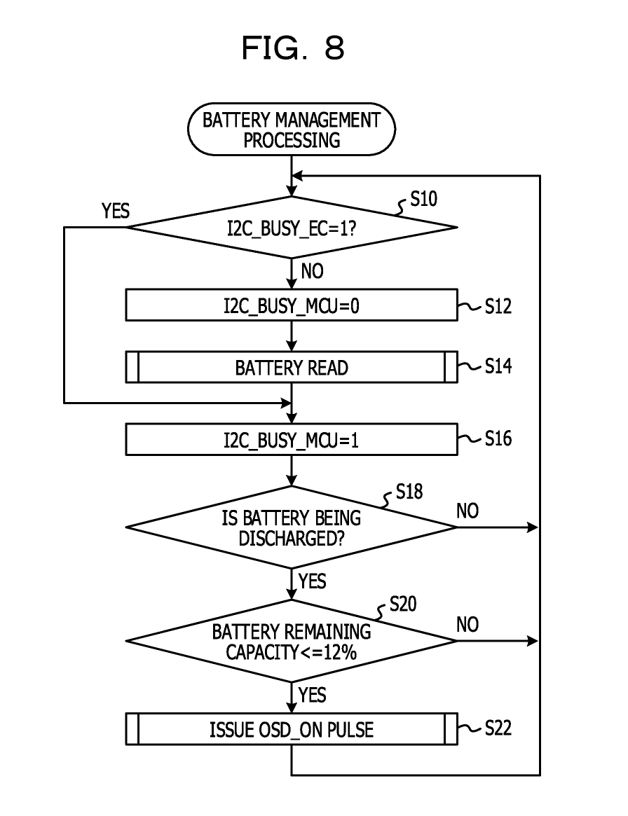

Battery management processing according to the present embodiment will next be described with reference to FIG. 8. FIG. 8 is a flowchart of an example of battery management processing according to one embodiment. Incidentally, the battery management processing is performed mainly by the USB microcomputer 301.

The obtaining unit 31 first determines whether or not the BUSY signal (I2C_BUSY_EC) issued by the power supply control microcomputer 307 is “1” (step S10). When the obtaining unit 31 determines that the BUSY signal (I2C_BUSY_EC) is “1,” the obtaining unit 31 proceeds to step S16. When the obtaining unit 31 determines that the BUSY signal (I2C_BUSY_EC) is not “1,” on the other hand, the obtaining unit 31 sets “0” to the BUSY signal (I2C_BUSY_MCU) issued by the USB microcomputer 301 (step S12). Thus, as illustrated in FIG. 6, the USB microcomputer 301 is selected, and access is allowed from the USB microcomputer 301 to the smart battery 308. Next, the obtaining unit 31 obtains the battery information retained by the smart battery 308 (step S14).

Next, in step S16, “1” is set to the BUSY signal (I2C_BUSY_MCU) (step S16). The USB microcomputer 301 therefore makes a transition from the state of being able to access the smart battery 308 to a ready state.

Next, the battery managing unit 36 determines whether or not the battery is being discharged (step S18). When the smart battery 308 is connected to an AC adapter, the battery managing unit 36 determines that the battery is not being discharged (is being charged), and returns to step S10. When the state of the BUSY signal (I2C_BUSY_EC) is not “1,” the obtaining unit 31 sets “0” to the BUSY signal (I2C_BUSY_MCU), and reads the battery information again (steps S10 to S14).

When the battery managing unit 36 determines in step S18 that the battery is being discharged, on the other hand, the battery managing unit 36 determines from the battery remaining capacity information included in the battery information whether the remaining capacity of the battery is equal to or lower than 12% (step S20). When the battery managing unit 36 determines that the remaining capacity of the battery is higher than 12%, the battery managing unit 36 returns to step S10. The obtaining unit 31 determines the state of the BUSY signal (I2C_BUSY_EC). When the BUSY signal (I2C_BUSY_EC) is not “1,” the obtaining unit 31 sets “0” to the BUSY signal (I2C_BUSY_MCU), and reads the battery information again (steps S10 to S14).

When the battery managing unit 36 determines in step S20 that the remaining capacity of the battery is equal to or lower than 12%, the battery managing unit 36 issues an OSD_ON pulse signal (step S22), and returns to step S10. Thus, the processing of steps S10 to S22 is performed periodically.

The battery management processing according to the present embodiment has been described above. According to such battery management processing, the USB microcomputer 301 periodically obtains the battery information retained in the smart battery 308. Thus, the battery information 301a2 stored in the register 301a of the USB microcomputer 301 is periodically updated to the latest battery information (see FIG. 5A). At this time, the USB microcomputer 301 sorts the battery information obtained from the smart battery 308 into fixed information such as a model number and the like and variable information such as the battery remaining capacity information and the like. When the USB microcomputer 301 has not obtained the fixed information, the USB microcomputer 301 obtains all of the information including the fixed information from the smart battery 308. When the USB microcomputer 301 has obtained the fixed information, on the other hand, the USB microcomputer 301 obtains only the battery information such as the battery remaining capacity information and the like as the variable information from the smart battery 308. This may shorten a time of access to the smart battery 308.

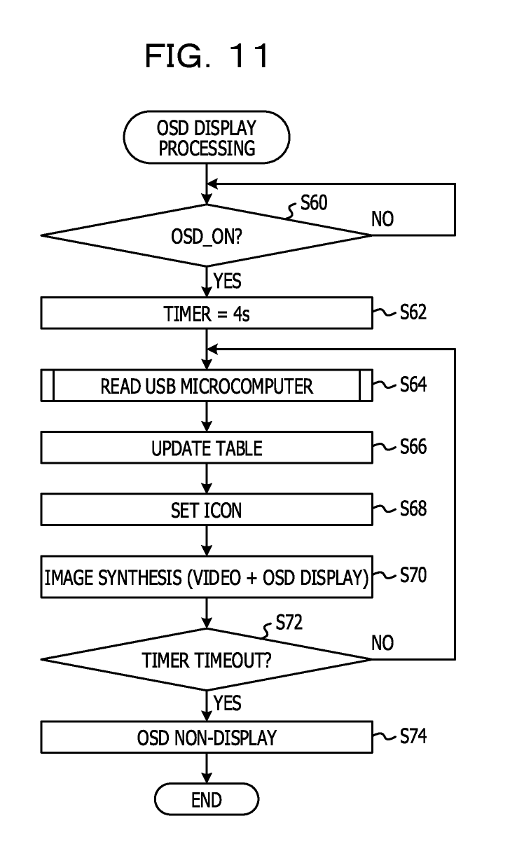

In addition, when the USB microcomputer 301 issues an OSD_ON pulse signal in step S22, the OSD_ON pulse signal is sent from the USB microcomputer 301 to the decoder processor 302, as illustrated in FIG. 4. The decoder processor 302 accordingly performs OSD display processing (see FIG. 11) to be described later.

In addition, in the present embodiment, when the battery information has not been obtained from the smart battery 308 after the passage of a given time (for example 40 minutes) since a start of the processing of obtaining the battery information in S14, it is determined that the smart battery 308 is not connected. In this case, access to I2C is not made until the issuance of an OSD display request in response to a change in the BUSY signal of the power supply control microcomputer 307 or an operation by the user of the Menu button 321, the up (+) button 322, or the down (−) button 323.

[Backlight Control Processing]

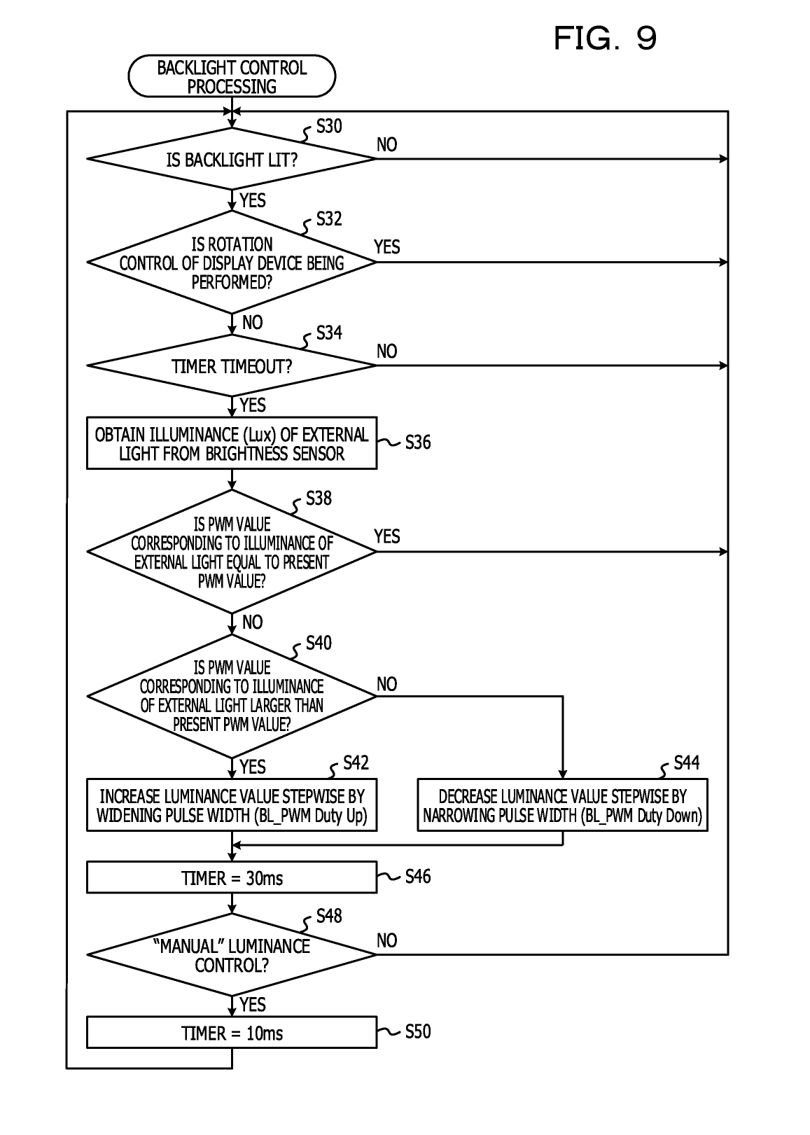

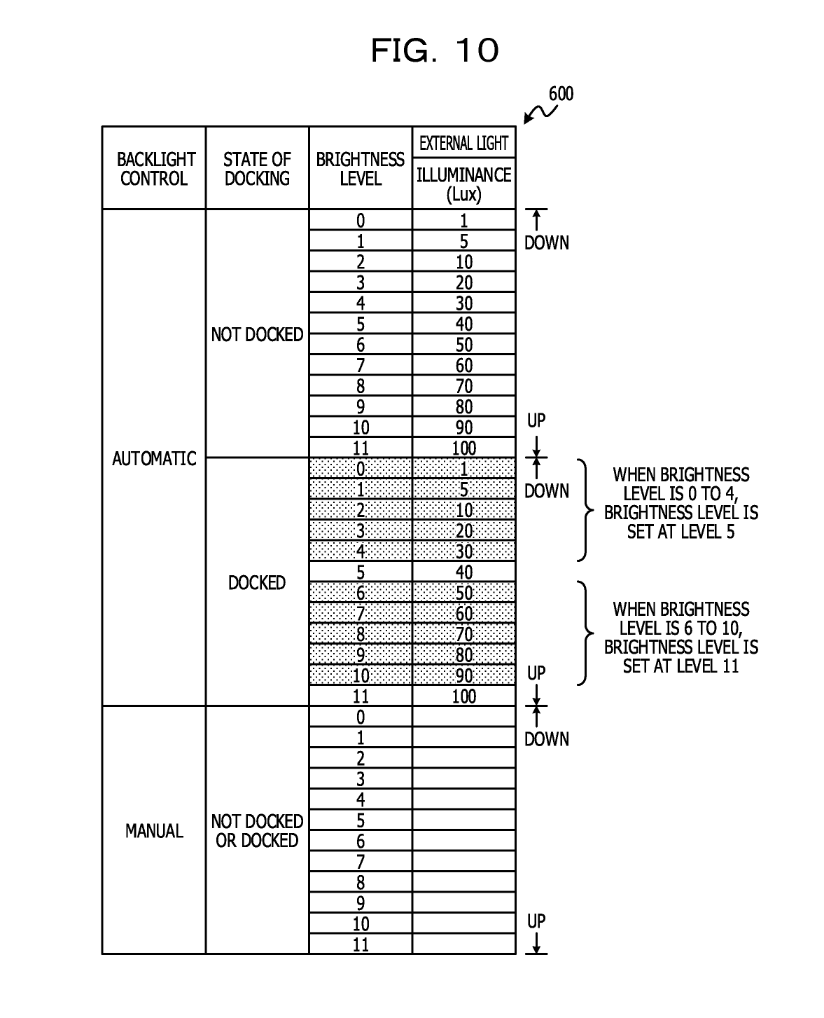

Backlight control processing according to the present embodiment will next be described with reference to FIG. 9 and FIG. 10. FIG. 9 is a flowchart of an example of backlight control processing according to one embodiment. FIG. 10 is a diagram illustrating an example of a backlight control table according to one embodiment. Incidentally, the backlight control processing is performed mainly by the USB microcomputer 301.

First, the obtaining unit 31 determines whether the backlight of the LCD panel 313 is lit (step S30). When the obtaining unit 31 determines that the backlight is not lit, the obtaining unit 31 repeats the processing of step S30 until the backlight is lit.

When the obtaining unit 31 determines that the backlight is lit, the obtaining unit 31 determines whether rotation control of the display device 3 is being performed (step S32). When the obtaining unit 31 determines that the rotation control is being performed according to rotation of a casing of the display device 3, the obtaining unit 31 returns to step S30 to repeat the processing of steps S30 and S32. When the obtaining unit 31 determines that the casing of the display device 3 is not rotating and that the rotation control is therefore not being performed, the obtaining unit 31 determines whether a timer has timed out (step S34). The timer is set to a given period (for example 30 minutes) in advance, and clocks time. When the obtaining unit 31 determines that the time-out has not occurred, the obtaining unit 31 returns to step S30 to repeat the processing of steps S30 to S34. When the obtaining unit 31 determines that the time-out has occurred, the obtaining unit 31 proceeds to step S36, and obtains a detected value of illuminance (Lux) of external light from a brightness sensor (not illustrated). Incidentally, the brightness sensor is an example of a sensor that is provided to the casing of the display device 3 and which detects the illuminance of external light in a place where the display device 3 is disposed.

Next, the luminance managing unit 37 determines whether a pulse width modulation (PWM) value based on the detected value of the illuminance of the external light is equal to a present PWM value (step S38). When the luminance managing unit 37 determines that the PWM value based on the detected value of the illuminance of the external light is equal to the present PWM value, the luminance managing unit 37 returns to step S30, and makes the processing from step S30 on down performed.

When the luminance managing unit 37 determines that the PWM value based on the detected value of the illuminance of the external light is not equal to the present PWM value, on the other hand, the luminance managing unit 37 determines whether the PWM value based on the detected value of the illuminance of the external light is larger than the present PWM value (step S40).

When the luminance managing unit 37 determines in step S40 that the PWM value based on the detected value of the illuminance of the external light is larger than the present PWM value, the luminance managing unit 37 increases the duty ratio of the PWM value stepwise by widening the pulse width of the PWM value, and thus brightens the backlight stepwise (step S42).

When the luminance managing unit 37 determines that the PWM value based on the detected value of the illuminance of the external light is smaller than the present PWM value, on the other hand, the luminance managing unit 37 decreases the duty ratio of the PWM value stepwise by narrowing the pulse width of the PWM value, and thus dims the backlight stepwise (step S44). Thus, the backlight of the LCD panel 313 is adjusted stepwise in consideration of an effect on the eyes of the user. The luminance information after the adjustment is retained in the register 301a of the USB microcomputer 301.

Next, the luminance managing unit 37 sets the timer to 30 minutes (step S46), and determines, after the passage of 30 minutes, whether luminance control is performed manually (step S48). For example, it is determined that luminance control is performed manually when the up (+) button 322 or the down (−) button 323 is pressed by a user operation. When the luminance managing unit 37 determines that manual luminance control is not performed, the luminance managing unit 37 returns to step S30 to repeat the processing from step S30 on down. When the luminance managing unit 37 determines in step 48 that luminance control is performed manually, on the other hand, the luminance managing unit 37 sets the timer to 10 minutes (step S50), and after the passage of 10 minutes, returns to step S30 to repeat the processing from step S30 on down.

The backlight control processing according to the present embodiment has been described above. According to the backlight control processing, the brightness level of the backlight may be controlled “automatically” or “manually” on the basis of a backlight control table 600 of FIG. 10, for example. For example, the brightness level of the backlight controlled “automatically” when the display device 3 is not docked with the main body device 1 may be controlled to be different from the brightness level of the backlight controlled “automatically” when the display device 3 is docked with the main body device 1. For example, on the basis of the backlight control table 600, when the display device 3 is not docked with the main body device 1, the luminance managing unit 37 may divide the brightness level into 12 steps according to the illuminance of detected external light, and change the PWM value. For example, the brightness level may be set at 0 when the external light has an illuminance 1, the brightness level may be set at 1 when the external light has an illuminance 5, and the brightness level may be set at 2, 3, . . . , and 11 when the external light has illuminances 10, 20, . . . , and 100. The relations between the detected values of the external light and the brightness levels are registered in the backlight control table 600 in advance, and may be changed as appropriate.

On the other hand, in the case where the display device 3 is docked with the main body device 1, when the brightness level corresponding to the illuminance of the detected external light is 0 to 4, the luminance managing unit 37 sets the brightness level at 5 as in the case where the brightness level corresponding to the illuminance of the external light is 5. In addition, when the brightness level corresponding to the illuminance of the external light is 6 to 10, the brightness level is set at 11 as in the case where the brightness level corresponding to the illuminance of the external light is 11. The brightness level may be thus set at 5 or 11, and the PWM value may be controlled accordingly.

The brightness level of the backlight controlled “manually” is controlled according to a luminance value set by the user irrespective of whether the display device 3 is docked with the main body device 1. Incidentally, the backlight control table 600 may be retained in the register 301a of the USB microcomputer 301.

[OSD Display Processing]

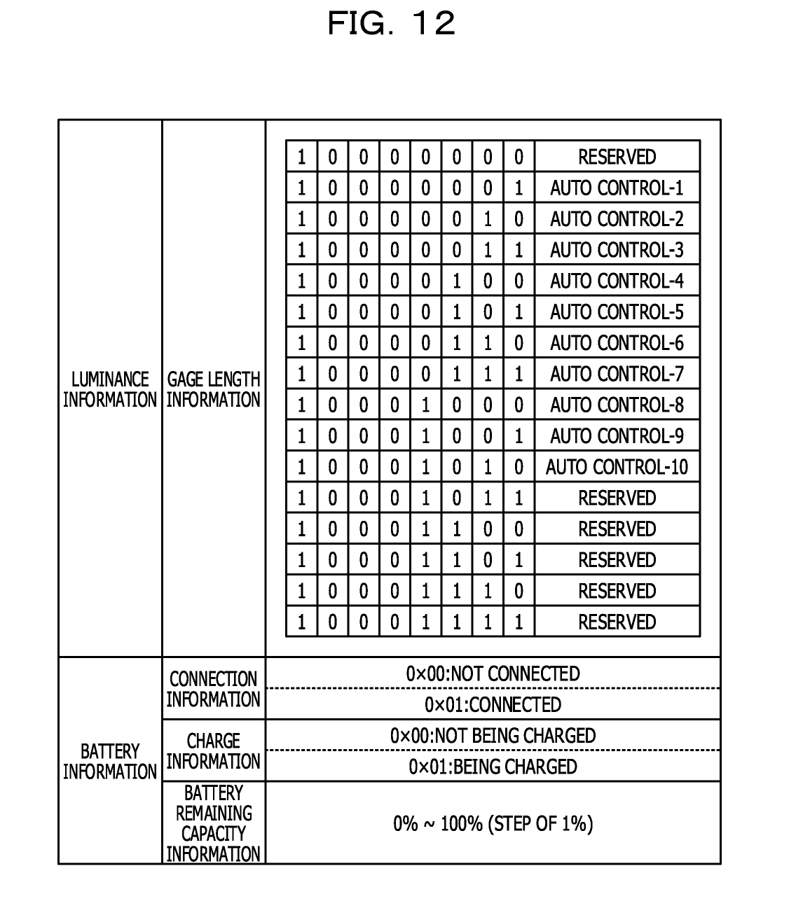

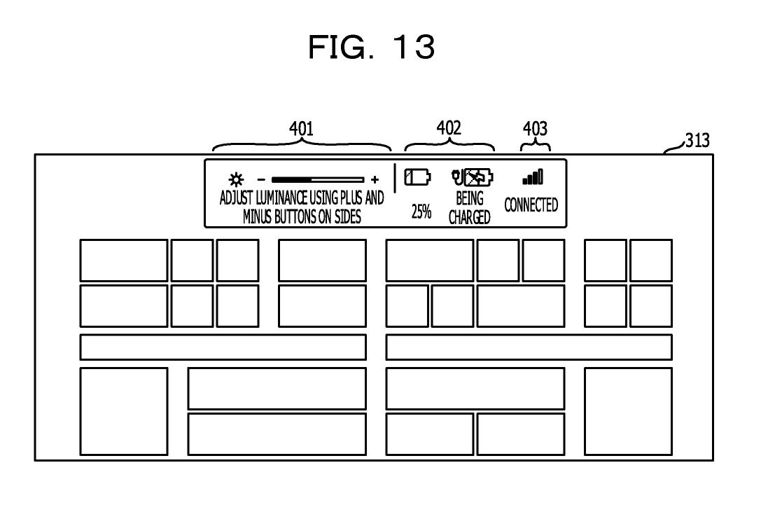

OSD display processing according to one embodiment will next be described with reference to FIGS. 11 to 13. FIG. 11 is a flowchart of an example of OSD display processing according to one embodiment. FIG. 12 is a diagram illustrating an example of information obtained by a decoder processor from a USB microcomputer according to one embodiment. The decoder processor and the USB microcomputer described with referring to FIG. 12 may be respectively the decoder processor 302 and the USB microprocessor 301 illustrated in FIG. 2. FIG. 13 is a screen example illustrating an example of OSD display according to one embodiment. Incidentally, the OSD display processing is performed mainly by the decoder processor 302.

First, the control unit 33 determines whether the OSD_ON pulse signal is input (step S60). When the OSD_ON pulse signal is not output from the USB microcomputer 301, the control unit 33 determines that the OSD_ON pulse signal is not input, and repeats the processing of step S60 until the OSD_ON pulse signal is output.

When the control unit 33 determines that the OSD_ON pulse signal is input, on the other hand, the control unit 33 sets four seconds in the timer (step S62), and obtains the luminance information and the battery information retained by the register 301a of the USB microcomputer 301 (step S64). Next, the storage unit 32 updates the update table 500 each time at least one of the luminance information and the battery information is obtained (step S66).

FIG. 12 illustrates an example of the state information of the display device 3, the state information being obtained by the decoder processor 302 from the USB microcomputer 301. The decoder processor 302 obtains the luminance information 301a1 stored in the register 301a. The luminance information 301a1 includes gage length information. FIG. 12 illustrates an example of the gage length information obtained by the decoder processor 302. In this case, the gage length information is 8-bit data, and indicates a gage length in ten steps from −1 to −10.

The decoder processor 302 also obtains the battery information 301a2 stored in the register 301a. The battery information 301a2 includes connection information indicating whether the smart battery 308 is connected, charge information indicating whether the smart battery 308 is being charged, and battery remaining capacity information indicating a percentage to which the smart battery 308 is charged.

Returns to FIG. 11, the display control unit 34 next sets the icon 401 (see FIG. 3), which allows the luminance of the LCD panel 313 to be adjusted, according to the gage length information included in the luminance information 501 on the basis of the update table 500 (step S68). The display control unit 34 also sets the icon 402 (see FIG. 3) for visually displaying the battery remaining capacity information and the charge information included in the battery information 502 on the basis of the update table 500 (step S68). The display control unit 34 also sets the icon 403 (see FIG. 3) representing the radio wave information 503 on the basis of the update table 500 (step S68).

Next, the display control unit 34 synthesizes an image transmitted by radio from the main body device 1 with the images of the icons 401, 402, and 403, thus superimposes the icons 401, 402, and 403 representing the states of the display device 3 on the image information, and displays the result on the LCD panel 313 (step S70).

The display control unit 34 next determines whether the timer has timed out (step S72). When the display control unit 34 determines that the timer has not timed out, the display control unit 34 returns to step S64 to repeat the processing of steps S64 to S72. When the display control unit 34 determines that the timer has timed out, the display control unit 34 sets the icons 401, 402, and 403 in a non-display state (step S74), and ends the present processing with only the image information displayed on the LCD panel 313.

The OSD display processing according to the present embodiment has been described above. According to such OSD display processing, the updated state information of the display device 3 may be reflected in the screen displaying the image information, and displayed in a state of being superimposed on the image information. Specifically, in the present embodiment, the processing of steps S64 to S72 is repeated for a given period (four seconds in this case). Hence, each time at least one of the luminance information 501, the battery information 502, and the radio wave information 503 stored in the update table 500 is updated, the display control unit 34 sets the icons representing the latest states of the display device 3 at the point in time, and makes OSD display of the icons on the screen. Therefore, the states of the display device 3 which states change during the given period may be notified to the user by changing the display of the icons 401, 402, and 403.

In particular, the USB microcomputer 301 according to the present embodiment manages the luminance information as one piece of state information of a monitoring object of the present embodiment, and obtains the battery remaining capacity information and the like. Then, the decoder processor 302 obtains the luminance information and the battery remaining capacity information from the USB microcomputer 301 in timing in which the OSD_ON pulse signal output from the USB microcomputer 301 is input to the decoder processor 302. The decoder processor 302 displays the icons for visually displaying the obtained luminance information and the obtained battery remaining capacity information such that the icons are superimposed on the image information. Thus, the decoder processor 302 may refrain as much as possible from performing processing other than image information transfer processing. That is, the display device 3 according to the present embodiment may make OSD display of the icons for displaying the states of the display device 3 such that the icons are superimposed on the image information without burdening the decoder processor 302.

For example, as illustrated in FIG. 13, according to the present embodiment, OSD display of the icons 401, 402, and 403 may be made such that the icons 401, 402, and 403 are superimposed on the image information displayed on the LCD panel 313. Further, according to the present embodiment, the latest states of the display device 3 may be notified to the user by visually changing the icons 401, 402, and 403, which are displayed for a given period, according to changes in the states of the display device 3. For example, the battery remaining capacity information stored in the update table 500 is updated in steps of 1%. Hence, according to the present embodiment, the icon 402 for visually displaying the battery remaining capacity information stored in the update table 500 may be updated and displayed in a state of being superimposed on the image information during the given period. Thus, the battery remaining capacity indicated by the icon 402 changes from 25% to 26%, 27%, . . . within the given period, or the battery remaining capacity changes from 25% to 24%, 23%, . . . within the given period. The states of the display device 3 may therefore be visually notified to the user.

It is to be noted that timing in which the decoder processor 302 starts the OSD display processing is when the battery remaining capacity of the smart battery 308 is equal to or lower than 12% of a maximum battery capacity, but is not limited to this. Other timing in which the decoder processor 302 starts the OSD display processing is, for example, when the user presses the Menu button 321, when the user changes the luminance value, when the radio wave is about to be interrupted, and when the radio wave is interrupted. Examples of times when the user changes the luminance value include a time when the user presses the up (+) button 322 or the down (−) button 323 and a time when the user touches the plus or minus button on the side which button is included in the icon 401.

The display device and the display control circuit have been described above on the basis of the foregoing embodiments. However, the display device and the display control circuit according to the present technology are not limited to the foregoing embodiments, but are susceptible of various modifications and improvements within the scope of the present technology. In addition, items described in the plurality of embodiments may be combined with each other within a scope where no inconsistency arises. In addition, the functions of the display device and the display control circuit may be configured by hardware, may be configured by software, or may be configured by combining hardware and software.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display device displaying image information transmitted from a main body device on a display, the display device comprising:
an obtaining unit configured to obtain state information of a monitoring object related to a state of the display device; and
a control unit configured to update an update table storing the state information in response to periodically obtaining the state information from the obtaining unit, update state display information for visually displaying the state information stored in the update table, and display the state display information in a state of being superimposed on the image information for a given period.

2. The device according to claim 1,
wherein there are a plurality of monitoring objects, and
wherein the control unit updates the update table each time state information of one of the plurality of monitoring objects is obtained, and updates a plurality of pieces of state display information for visually displaying a plurality of pieces of state information stored in the update table and displays the plurality of pieces of state display information in a state of being superimposed on the image information for the given period in response to detecting an instruction to display the state display information in a state of being superimposed on the image information.

3. A display control circuit incorporated in a display device displaying image information transmitted from a main body device on a display, the display control circuit comprising:
a microcomputer configured to obtain state information of a monitoring object related to a state of the display device; and
a processor configured to update an update table storing the state information in response to periodically obtaining the state information from the microcomputer, update state display information for visually displaying the state information stored in the update table, and display the state display information in a state of being superimposed on the image information for a given period.

4. The circuit according to claim 3,
wherein there are a plurality of monitoring objects, and
wherein the processor updates the update table each time state information of one of the plurality of monitoring objects is obtained, and updates a plurality of pieces of state display information for visually displaying a plurality of pieces of state information stored in the update table and displays the plurality of pieces of state display information in a state of being superimposed on the image information for the given period in response to detecting an instruction to display the state display information in a state of being superimposed on the image information.

5. A display method displaying image information transmitted from a main body device on a display, the display method comprising:
obtaining state information of a monitoring object related to a state of a display device; and
updating, by a computer processor, an update table storing the state information in response to periodically obtaining the state information from an obtaining unit, updating state display information for visually displaying the state information stored in the update table, and displaying and controlling the state display information in a state of being superimposed on the image information for a given period.

6. The method according to claim 5,
wherein there are a plurality of monitoring objects, and
wherein the controlling updates the update table each time state information of one of the plurality of monitoring objects is obtained, and updates a plurality of pieces of state display information for visually displaying a plurality of pieces of state information stored in the update table and displays the plurality of pieces of state display information in a state of being superimposed on the image information for the given period in response to detecting an instruction to display the state display information in a state of being superimposed on the image information.
